(19) United States
(12) Patent Application Publication
(10) Pub. No.: US 2023/0206156 A1
(43) Pub. Date: Jun. 29, 2023

(54) SMART KEY PERFORMANCE INDICATORS SELECTION SUPPORT

(71) Applicant: KONINKLIJKE PHILIPS N.V., EINDHOVEN (NL)

(72) Inventors: Dieter Maria Alfons van de Craen, Eindhoven (NL); Maartje Helena Schonenberg, Eindhoven (NL); Joep Joseph Benjamin N van Berkel, Eindhoven (NL); Chrisoph Tobias Wirth, Eindhoven (NL)

(21) Appl. No.: 17/923,747

(22) PCT Filed: Apr. 30, 2021
(86) PCT No.: PCT/EP2021/061360

§ 371 Date: Nov. 7, 2022

Related U.S. Application Data
(60) Provisional application No. 63/022,792, filed on May 11, 2020.

(51) Int. Cl. G06Q 10/0639; G06Q 10/0637

(52) U.S. Cl. CPC G06Q 10/06393; G06Q 10/06375

(57) ABSTRACT

A system and method for selecting a set of value-base healthcare measures, including: presenting a ontological hierarchy to a user on a graphical user interface, wherein the ontological hierarchy includes the hierarchical relationship between healthcare measures and value-based healthcare topics; receiving user input indicating a set of topics from the ontological hierarchy; receiving user input indicating value-based optimization parameters; determining a list of healthcare measures based upon the set of topics and optimization parameters; and displaying a list of measures to the user on the graphical user interface.

### TECHNICAL FIELD

Various exemplary embodiments disclosed herein relate generally to a system and method for supporting the smart selection of key performance indicators.

### BACKGROUND

Value-based care is the intersection of cost and quality. Value-based initiatives shift the care delivery focus from volume to value and redefine financial incentives toward reduced costs. In this model, physicians must think about the entire patient experience among all care settings and between episodic visits.

From a cost perspective, the total cost of care encompasses all spending for the patient—and the patient population as a whole-grouped, benchmarked and analyzed by condition. As the provider mindset shifts to address this model, taking the appropriate steps in terms of patient engagement, technology and workflow are the key first steps to value-based success.

### SUMMARY

A summary of various exemplary embodiments is presented below. Some simplifications and omissions may be made in the following summary, which is intended to highlight and introduce some aspects of the various exemplary embodiments, but not to limit the scope of the invention. Detailed descriptions of an exemplary embodiment adequate to allow those of ordinary skill in the art to make and use the inventive concepts will follow in later sections.

Various embodiments relate to a method for selecting a set of value-base healthcare measures, including: presenting an ontological hierarchy to a user on a graphical user interface, wherein the ontological hierarchy includes the hierarchical relationship between healthcare measures and value-based healthcare topics; receiving user input indicating a set of topics from the ontological hierarchy; receiving user input indicating value-based optimization parameters; determining a list of healthcare measures based upon the set of topics and optimization parameters; and displaying a list of measures to the user on the graphical user interface.

Various embodiments are described, wherein the ontological hierarchy includes an aim category, an aim sub-category, generic topic KPIs level, and a healthcare measures level.

Various embodiments are described, wherein each healthcare measure has an associated topic coverage value and an implementation or measure cost.

Various embodiments are described, wherein determining a list of healthcare measures based upon the set of topics and optimization parameters further includes determining the list of healthcare measures that minimizes the total cost of the healthcare measures within the constraint that the set of topics are covered based upon a specified value for each topic.

Various embodiments are described, wherein determining a list of healthcare measures based upon the set of topics and optimization parameters further includes: solving the optimization problem of:

$$minimize {\sum }_{m ∈ M} {C}_{m} within the constraint that ∀ t ∈ T : {v}_{t} \leq {\sum }_{m ∈ M} c {s}_{m}^{t}$$

where M is a set of healthcare measures associated with the set of topics, Cₘ are the cost associated with each measure m, t is a topic in the set topics T, vₜ is the value associated with the topic t, and csₘ^{t} is the strength of coverage of a topic t, measure m.

Various embodiments are described, wherein determining a list of healthcare measures based upon the set of topics and optimization parameters further includes determining the list of healthcare measures that maximizes the total value of the topics within the constraint total cost of the healthcare measures is less than a cost constraint.

Various embodiments are described, wherein determining a list of healthcare measures based upon the set of topics and optimization parameters further includes: solving the optimization problem of:

$$maximize {\sum }_{t ∈ T} ( {v}_{t} \times min ( 1 \vert \tilde{{v}_{t}} ) )$$

$$where \tilde{{v}_{t}} := {\sum }_{m ∈ M} c {s}_{m}^{t} ∀ t ∈ T$$

$$within the constraint that cost limit {\sum }_{m ∈ M} {C}_{m} \leq L$$

where M is a set of healthcare measures associated with the set of topics, Cₘ are the cost associated with each measure m t is a topic in the set topics T, vₜ is the value associated with the topic t, csₘ^{t} is the strength of coverage of a topic t, measure m, and L is the cost constraint.

Various embodiments are described, wherein determining a list of healthcare measures based upon the set of topics and optimization parameters further includes: determining a subset of the list of topics that maximizes the total value of the topics within the constraint total cost of the healthcare measures is less than a cost constraint; and determining the list of healthcare measures that minimizes the total cost of the healthcare measures associated with the subset of topics within the constraint that the total cost of the healthcare measures is less than a cost constraint.

Various embodiments are described, further including determining the coverage value of each topic and displaying the coverage value of each topic on the graphical user interface.

Various embodiments are described, further including determining the coverage of each topic provided by each healthcare measure and displaying the coverage by each healthcare measure on the graphical user interface.

Further various embodiments relate to a measure optimization system for selecting a set of value-base healthcare measures, including: a memory; a processor coupled to the memory, wherein the processor is further configured to: present a ontological hierarchy to a user on a graphical user interface, wherein the ontological hierarchy includes the hierarchical relationship between healthcare measures and value-based healthcare topics; receive user input indicating a set of topics from the ontological hierarchy; receive user input indicating value-based optimization parameters; determine a list of healthcare measures based upon the set of topics and optimization parameters; and display a list of measures to the user on the graphical user interface.

Various embodiments are described, wherein the ontological hierarchy includes an aim category, an aim sub-category, generic topic KPIs level, and a healthcare measures level.

Various embodiments are described, wherein each healthcare measure has an associated topic coverage value and an implementation cost.

Various embodiments are described, wherein determining a list of healthcare measures based upon the set of topics and optimization parameters further includes determining the list of healthcare measures that minimizes the total cost of the healthcare measures within the constraint that the set of topics are covered based upon a specified value for each topic.

Various embodiments are described, wherein determining a list of healthcare measures based upon the set of topics and optimization parameters further includes: solving the optimization problem of:

$$minimize {\sum }_{m ∈ M} {C}_{m} within the constraint that ∀ t ∈ T : {v}_{t} \leq {\sum }_{m ∈ M} c {s}_{m}^{t}$$

where M is a set of healthcare measures associated with the set of topics, Cₘ are the cost associated with each measure m, t is a topic in the set topics T, vₜ is the value associated with the topic t, and csₘ^{t} is the strength of coverage of a topic t, measure m.

Various embodiments are described, wherein determining a list of healthcare measures based upon the set of topics and optimization parameters further includes determining the list of healthcare measures that maximizes the total value of the topics within the constraint total cost of the healthcare measures is less than a cost constraint.

Various embodiments are described, wherein determining a list of healthcare measures based upon the set of topics and optimization parameters further includes: solving the optimization problem of:

$$maximize {\sum }_{t ∈ T} ( {v}_{t} \times min ( 1 \vert \tilde{{v}_{t}} ) )$$

$$where \tilde{{v}_{t}} := {\sum }_{m ∈ M} c {s}_{m}^{t} ∀ t ∈ T$$

$$within the constraint that cost limit {\sum }_{m ∈ M} {C}_{m} \leq L$$

where M is a set of healthcare measures associated with the set of topics, Cₘ are the cost associated with each measure m, t is a topic in the set topics T, vₜ is the value associated with the topic t, csₘ^{t} is the strength of coverage of a topic t, measure m, and L is the cost constraint.

Various embodiments are described, wherein determining a list of healthcare measures based upon the set of topics and optimization parameters further includes: determining a subset of the list of topics that maximizes the total value of the topics within the constraint total cost of the healthcare measures is less than a cost constraint; and determining the list of healthcare measures that minimizes the total cost of the healthcare measures associated with the subset of topics within the constraint that the total cost of the healthcare measures is less than a cost constraint.

Various embodiments are described, wherein the processor is further configured to determine the coverage value of each topic and displaying the coverage value of each topic on the graphical user interface.

Various embodiments are described, wherein the processor is further configured to determine the coverage of each topic provided by each healthcare measure and displaying the coverage by each healthcare measure on the graphical user interface.

### BRIEF DESCRIPTION OF THE DRAWINGS

In order to better understand various exemplary embodiments, reference is made to the accompanying drawings, wherein:

FIG. 1 illustrates a graphical user interface that presents the ontological hierarch of measures;

FIG. 2 illustrates a flow diagram of a user using the optimization system; and

FIG. 3 illustrates an exemplary hardware diagram 300 for selecting a set of optimized measures and displaying those measures to a user.

To facilitate understanding, identical reference numerals have been used to designate elements having substantially the same or similar structure and/or substantially the same or similar function.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments.

Value-based care is the intersection of cost and quality. Value-based initiatives shift the care delivery focus from volume to value and redefine financial incentives toward reduced costs. In this model, physicians must think about the entire patient experience among all care settings and between episodic visits.

From a cost perspective, the total cost of care encompasses all spending for the patient—and the patient population as a whole-grouped, benchmarked and analyzed by condition. As the provider mindset shifts to address this model, taking the appropriate steps in terms of patient engagement, technology and workflow are the key first steps to value-based success.

Managing the overall health and care delivery for a patient population requires an effective technology solution to collect, aggregate and analyze patient data. In addition to aiding in predictive modeling and implementing evidence-based care plans, collecting clean, quality data strengthens reporting and helps ensure that the healthcare provider receives appropriate payments and incentives—while avoiding costly penalties. The cost and difficulty of collecting patient data varies widely, so it is important to understand the importance of the data in assessing value-based care versus the cost of collecting the data.

Establishing effective clinical workflows-both at the micro and macro levels-ensures clear lines of responsibility, establishes best practices for effectively collecting and reporting on required data, and promotes understanding of the comprehensive care requirements for patients and patient populations.

There are different ways to define value. The National Academy of Medicine has developed a widely accepted approach that describes high-value health care as: safe, timely, effective, efficient, equitable and patient-centered—STEEEP for short. The Institute for Healthcare Improvement later translated this into a framework for action, the Triple Aim, which is made up of better patient outcomes, improved patient satisfaction and lower costs. The Triple Aim has since been expanded to the Quadruple Aim, which includes physician and health care professional well-being.

The health care value equation provides one way to understand how well an organization is performing vis-a-vis the framework of the Quadruple Aim. The equation defines value as the quality of care—made up of outcomes, safety and service—divided by the total cost of patient care over time.

Physicians play crucial roles in moving the health care system toward this model by minimizing low-value care and focusing on care that is high value and necessary. The first step is to identify and classify gaps that lead to waste, errors and missed opportunities. These include overuse, when care has a greater potential for harm than benefit; misuse, when appropriate care is selected but results in preventable complications; and underuse, when opportunities to provide high-value care are missed.

Due to the shift towards value-based care, continuously measuring the outcomes of solutions offered is becoming increasingly important in the healthcare domain. Implementation of measures help potential end-users (e.g., providers and medical specialties, health care organizations, health plans, policymakers, etc.) to assess performance results for both accountability and performance improvement around the Quadruple Aim to deliver high-quality and efficient healthcare to individual patients or populations. Measures are owned and maintained by the measure stewards (e.g. Agency for Healthcare Research and Quality (AHRQ), Centers for Medicare & Medicaid Services (CMS), National Committee for Quality Assurance (NCQA), and Health Services Advisory Group (HSAG)). Measure stewards can also be individuals or organizations and quite often measure developers. Measure constructs contains specification of the target population to whom the measure applies, identification of those from the target population who achieved the specific measure focus (e.g., condition, event, outcome), measurement time window, exclusions, risk adjustment and stratification, data sources and measure computation (e.g., rate, ratio, aggregation function). However, there are still challenges to overcome. There is a plethora of specified outcome measures and there is currently limited consensus or standardized outcomes sets of what to measure. Moreover, measures require different types of data sources, each with their own set of challenges regarding sufficient data quality and cost of assessing and processing the data as well as the effort needed to collect the data. This results in a tension for healthcare organizations as, on the one hand, they desire to track a broad set of outcome measures, while, on the other hand, they are restricted by limited resources to implement and maintain the implementation of the measures. Embodiments of a system will be described that improves the selection process of outcome measures for a healthcare organization which addresses this tension.

Healthcare organizations are increasingly making the transition towards value-based care. However, to get buy-in from decision makers and prove the value of care and care solutions healthcare organizations offer to patients, it is essential to measure patient outcomes in a systematic manner. Furthermore, as healthcare organizations increasingly become incentivized on outcomes rather than on the number of services delivered, it becomes crucial to find effective solutions to affect the health care organizations' key performance indicators (KPIs) and show the effectiveness of the offered solutions. Continuously measuring the outcomes of a program is needed to establish real world data and evidence for a solution and enable the healthcare organizations to:
understand performance status for an intervention program or department in a target population;
support continuous improvement initiatives to become a center of clinical excellence;
engage in peer-to peer comparison to identify optimal care pathways and evidence of best practice; and
increase readiness for participation in performance-based reimbursement models.

The Quadruple Aim describes an approach to conceptualize and optimize performance in the health care system through the simultaneous pursuit of four dimensions: 1) better health outcomes; 2) improved patient experience; 3) lower cost of care; and 4) improved staff experience.

Organizing the measures according to the Quadruple Aim results in simultaneously pursuing these four dimensions and as a result, the care provided by healthcare organizations is more likely to deliver value to patients and populations.

There is a large number of potential measures and there is currently no consensus or standards of what to measure. For example, over 350 measures have been identified that could be used in the context of chronic conditions such as congestive heart failure (CHF), chronic obstructive pulmonary disease (COPD), diabetes, and frail elderly patients. Presenting this large number of measures to a user becomes overwhelming when trying to determine which measures are the most import to providing high value care to patients. Moreover, measures require different types of data sources, each with their own set of challenges regarding the cost, quality, and validity of the data. Some measures might even be disregarded due to the effort and cost it would take in order to collect the necessary data. For example, the actual cost for a procedure is often not known as the only cost data available is insurance reimbursement for the procedure. The effort to obtain the actual underlying cost may be difficult to determine and collect. The actual cost may include the time required to perform the procedure, the supplies needed to perform the procedure, the cost of the equipment that may be used in the procedure, etc. Another example is the costs incurred outside the hospital. The hospital may not be able to easily gather medical costs for treatments or doctor visits for a patient that are done outside the hospital, but that affect the outcome of the care. To collect such data would require information sharing agreements and capabilities that currently do not exist. This results in a tension for healthcare organizations as, on the one hand, they desire to track measures that cover the Quadruple Aim extensively, while, on the other hand, they are restricted by limited resources to implement and maintain the implementation of the relevant measures. The embodiments described herein addresses this tension by selecting a set of outcome measures that maximizes the ratio of the amount of coverage of the Quadruple Aim to the amount of resources required to implement and compute these outcomes.

The healthcare measures may be organized by topics into a ontological hierarchy that can assist in determining the relationship of a measure to a topic of interest. For example, a patient's pulse oximeter reading may be useful in treating patients with CHF and COPD. This ontological hierarchy may be developed based upon a specific facility's or organization's own input and focus, or such hierarchies may be found in various sources of literature and publications or may be developed across a set of related organizations. Further, any given measure may be related to various topics with differing levels of importance to each topic. Examples of topics may be healthcare utilizations or effective clinical care. This hierarchy may be used to assist the user in selecting topics of interest and hence associated measures that could be influential in achieving the desired value and cost objectives. Then an optimization may be done to determine the specific measures to use to achieve the desired value and cost objectives. This ontological hierarchy may be illustrated graphically to make the selection of topics easier for the user.

An embodiment of a measure optimization system to improve the selection process of outcome measures for a healthcare organization is described herein. The measure optimization system may use the following three-step process: 1) identification of those areas within the Quadruple Aim that the organization wants to track and their importance according the interest of the healthcare organization; 2) identification of a set of outcome measures that best addresses the interest of the healthcare organization within given financial and resource constraints for measure implementation and according to a selected optimization function; and 3) presentation of the selected outcomes.

In the first step, the process starts by using a selection tool that presents the outcome measures in a graphical user interface and uses an ontological hierarchy. The ontological hierarchy is important as it provides the user topics of interest and their associated measures. The user will select topics of interest and indicate their importance. Each topic will be covered by at least one but typically many outcome measures that cover this topic. Several variations of this selection are possible and some of these will be described below. At the lowest level of the hierarchy, the implementable patient-level measures are found. For each implementable measure m, a cost function Cₘ represents the cost it takes to implement the measure and collect the data related to the measure. Several elements may be considered to define Cₘ, such as the amount of data needed, the resources required to collect the data, the complexity to dean the data, and the complexity to compute the measure. It is also noted that a measure m may cover more than a single topic. In such a situation, a measure m that covers multiple topics may be desirable, because the cost of collecting the data associated with this measure is spread across the multiple topics, making such a measure more valuable because of its fixed cost but influencing a number of topics of interest. Such measures may beneficially decrease the overall cost for measuring a number of—outcomes for a number of different topics. Further, a given measure m may be very important and specific to a given topic, but only have a small influence on another topic. Other measures m may influence a number of topics but with varying relative importance to those topics.

In the second step, the system will compute, based on the selection of one or more optimization functions, the combination of outcome measures that returns the optimal solution for those functions.

In the final step, the selected outcome measure sets and their respective cost to implement are presented to the user in a graphical user interface.

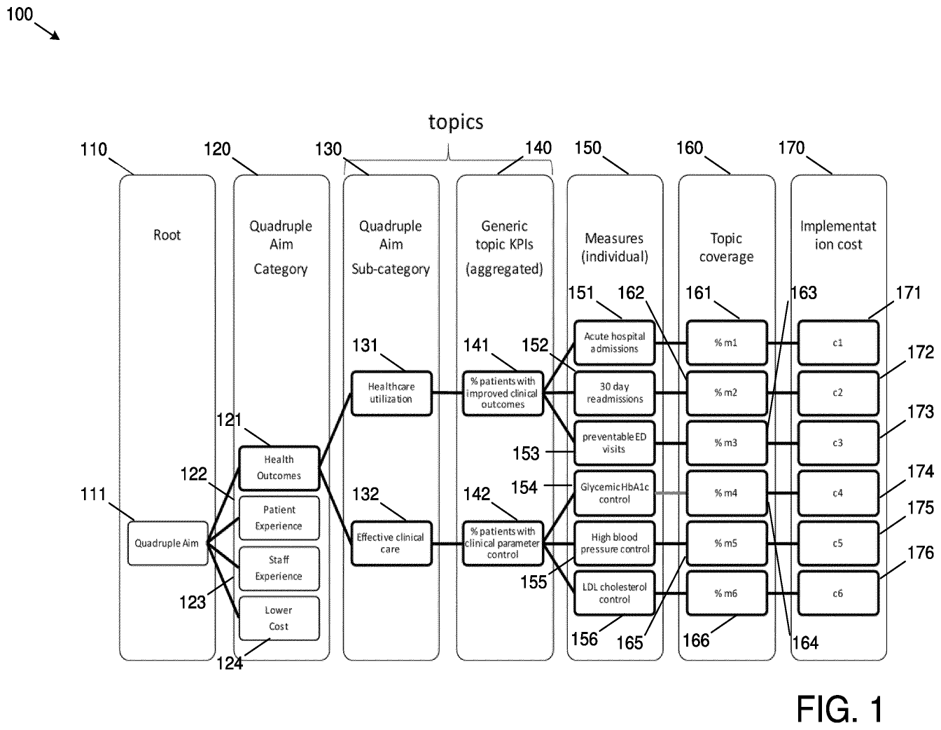

A prerequisite for the system is the availability of the ontological hierarchy of outcome measures. As described above, the Quadruple Aim describes an approach to conceptualize and optimize performance in the health care system. In describing embodiments of the system described herein, the availability of an ontological hierarchy of outcome measures is assumed with the Quadruple Aim as a top level and the implementable outcome measures as a lowest level. Such a hierarchy may include an inventory of outcome measures for a selected number of chronic conditions. In order for the user to select topics and potentially other options, a graphical user interface will be used. FIG. 1 illustrates a graphical user interface 100 that presents the ontological hierarchy of measures.

The graphical user interface 100 includes seven levels illustrated from left to right of: root 110; Quadruple Aim category 120; Quadruple Aim sub-category 130; generic top KPIs 140; individual measures 150; topic coverage 160; and implementation cost 170. The root level has a Quadruple Aim 111 icon that may be selected by a user to seek to determine optimized measures for a specific desired outcome. As the graphical user interface 100 may be part of an organization's larger data system, other icons may be present on the root level 110 that provide other functionality to the user, for example KPIs used in clinical operations centers assessing information from across care settings (e.g., emergency care, intensive care, general ward, post-acute care, remote patient monitoring and home patient engagement) fed by data from clinical systems, devices or apps. Once the user selects the Quadruple Aim icon 111, the Quadruple Aim category level opens up and displays icons for health outcomes 121, patient experience 122, staff experience 123, and lower cost 124. In this example the user selected the health outcomes icon 121, which then opens up the Quadruple Aim sub-category and displays icons for healthcare utilization 131 and effective clinical care 132. In the next level, generic topic KPIs 140, a % of patients with improved clinical outcome icon 141 associated with the healthcare utilization icon 131 is displayed. Also, a % of patients with clinical parameter control icon 142 associated with the effective clinical care icon 132 is displayed. The next level is the measures level 150. The measures level 150 shows icons for acute hospital admissions 151, 30 day readmissions 152, and preventable ED visits 153 associated with the % of patients with improved clinical outcomes icon 141. Further, the measures level 150 shows icons for glycemic HbA1c control 154, high blood pressure control 155, and LDL cholesterol control 156 associated with the % of patients with clinical parameter control icon 142. Each of the measures 151-156 has associated topic coverage values m₁-m₆ 161-166 and implementation cost C₁-C₆ 171-176.

Examples of measures that may affect multiple topics may include EQ-5D, SF-12, and the number of emergency department (ED) visits. The EQ-5D measure include five dimensions: mobility, self-care, usual activities, pain/discomfort and anxiety/depression. EQ-5D is a standardized instrument for measuring generic health status. It has been widely used in population health surveys, clinical studies, economic evaluation and in routine outcome measurement in the delivery of operational healthcare. These various dimensions can effect multiple topics of interest. The SF-12 is a 12-item, patient-reported survey of patient health. SF-12 assesses mental and physical patient information which may apply to a number of different topics. Further, utilization measures such as ED visits also serve as proxies for cost of care.

The graphical user interface 110 is shown as an example. For example, generic KPIs may be associated with multiple Quadruple Aim subcategories. Likewise, measures may be associated with multiple generic topic KPIs. Also many more Quadruple Aim sub-categories, generic topic KPIs, and measures may be available and displayed based upon the specific ontological hierarchy and the input choices made by the user. At the Quadruple Aim category level 120, the Quadruple Aim sub-category level 130, and the generic topic KPIs level 140 more than one icon may be selected to be included in the optimization process. Further, at the measures level 140 or generic topic KPIs level 140, the user may deselect certain icons if they are not to be part of the optimization.

The depicted graphical user interface 100 allows for a number of additional options for the user to apply. These options may include: the selection of implementable measures as must-haves; the selection of data sources that are available; the selection of a number of conditions to which measures should apply; and the selection of measures that belong to outcomes sets created by standardization efforts such as by the International Consortium for Health Outcomes Measurement (ICHOM).

As a result, the information that is required for each implementable measure depends on the options that will be supported by the measure optimization system. At a minimum, for each measure the user has access to the set of topics it applies to in the hierarchy and its cost function. The graphical user interface 100 also illustrates an expression of the strength of coverage of each topic. This allows for creating a differentiation based on the quality of coverage for a topic by different measures. For example, a certain generic measure may cover a number of topics in a limited manner, but a very specific measure may only cover a single topic but at a much deeper level.

Examples of the optimization process implemented by the measure optimization system will now be described. Define the measure cost Cₘ of a measure m as

Cₘ=implementation cost of m+cost to collect the data to compute m.

This measure cost reflects the difficulty to implement the measure. More cost elements may be added to this definition of Cₘ. For simplicity, it is assumed that all cost can be expressed in the same unit of measurement, such as a monetary value, number of hours of staff or equipment time, the number of units of a certain type of equipment, etc. The cost may also include, for example, the cost of collecting a variety of different types (e.g., administrative and clinical data) of information that may be combined, which adds complexity and hence cost. Also the minimum number patients or patient-time needed to collect data to observe a minimal detectable effect with statistical significance can add to the cost of that measure. For example, if a certain event is only observed after 1 patient-month, one patient needs to be followed for 10 months or 5 similar patients for 2 months to arrive at the same outcome of 10 observed events.

Next, T denotes the set of topics that are addressed by a measure m, and vₜ the value assigned to each topic t from the set of topics T. The value vₜ may be developed in collaboration with a user of the measure optimization system. In other embodiments, generic values may be determined based upon evaluating the value placed on the topics across a number of different users of the measure optimization system. Such generic values may be a starting point for these values a, that may then be further modified by the user of the system. Then the values assigned by the user to all selected topics are rescaled and normalized to a range of 0 to 1, and non-selected topics are represented by a value of zero. When only topics are selected and no value is assigned, all selected topics are assigned a value of one. Further, the expression of the strength of coverage of each topic t may be denoted by a measure m with csₘ^{t}. The values csₘ^{t} may be part of the ontological hierarchy based upon various user input and other studies determining the strength of the relationship between the measure and the topic. This strength of coverage can be used to ensure that sufficient measures have been used to provide complete coverage of a topic selected by the user as will be reflected in the optimizations described below. This strength will be rescaled/normalized such that all strengths are within a range of 0 to 1. So the strength of coverage may be thought of as a measure providing a percentage of coverage of a specified topic. When a measure does not cover a topic, a strength of zero is assigned. Another alternative is that no strengths are assigned and only an indication is used whether a topic is covered or not by a measure. In that case, a strength of one is assigned to measures that cover a topic.

The measure optimization system will compute the set of implementable measures M that will be proposed for implementation by the healthcare organization. Depending on the selected use case, the system will solve the corresponding objective function. When the user is interested in finding the set of implementable measures that covers all selected topics at a minimal cost the following function may be solved:

$$minimize {\sum }_{m ∈ M} {C}_{m} within the constraint that ∀ t ∈ T : {v}_{t} \leq {\sum }_{m ∈ M} c {s}_{m}^{t}$$

$$( i . e . , all topics are sufficiently covered )$$

This optimization minimizes the sum of the cost across all measures with the constraint that for all topics t that are part of the topics of interest T selected by the user, all topics are sufficiently covered. This is computed by summing the strength of coverage for each topic csₘ^{t} across all of the measures chosen in the optimization. This sum must be greater than or equal to the value vₜ associated with the topic. Typical optimization techniques such as integer programming may be used to solve the optimization problem. The output of the optimization is a set of measures that have the minimum cost that provides the specified topic coverage.

A second optimization approach may be used in a situation where the user has limited resources and they are trying to find the maximum coverage within a cost limitation. When the user is interested in finding the set of measures that covers as much as possible of the topics within a cost limit L, the following optimization problem will be solved:

$$maximize {\sum }_{t ∈ T} ( {v}_{t} \times min ( 1 \vert \tilde{{v}_{t}} ) )$$

$$where \tilde{{v}_{t}} := {\sum }_{m ∈ M} c {s}_{m}^{t} ∀ t ∈ T$$

$$within the constraint that cost limit {\sum }_{m ∈ M} {C}_{m} \leq L$$

$$( total cost is within the set limit L )$$

This optimization seeks to maximize the value achieved using the measures by maximizing the sum of the values vₜ across all topics within a cost limit L Each summand vₜ is either scaled by the sum of all strength of coverage csₘ^{t} for each topic t, denoted \tilde{v}ₜ, when the measure set M does not match up to complete coverage of this topic or each summand is limited to its given value if \tilde{v}ₜ>1 and thus the measure set M would redundantly exceed complete coverage of this topic. Further, the optimization ensures that the cost of the measures is less than a cost limit L As before, typical optimization techniques such as integer programming may be used to solve the optimization problem. The output of the optimization is a set of measures that have the maximum value within a cost limit.

A hybrid approach may be used, where the second optimization is done first. This generates a set of topics T with values a, that may then be used in the first optimization to minimize cost based upon refined values for a, or for a cost interval around the initial cost limit L

The above optimization are examples of two different optimizations that may be used to select the measures that achieve the desired goals of the user, but other optimizations may be used to achieve other goals of the user.

As described above the output of the measure optimization system is a set of selected relevant outcome measures. This list of measures may be presented on the graphical user interface 100. This could simply be a list of the selected measures. Alternatively, the measures output from the measure optimization system may be uniquely highlighted on ontological hierarchy shown in the graphical user interface 100. Additionally, the graphical user interface 100 may provide an indication of the amount of coverage of each of the user selected topics based upon the determined measures. This coverage value may be indicated by a number by each topic or a graphical indication using for example bars or pie charts. Also for each measure, an indication may be provided regarding the amount of coverage that each measure provides to each topic.

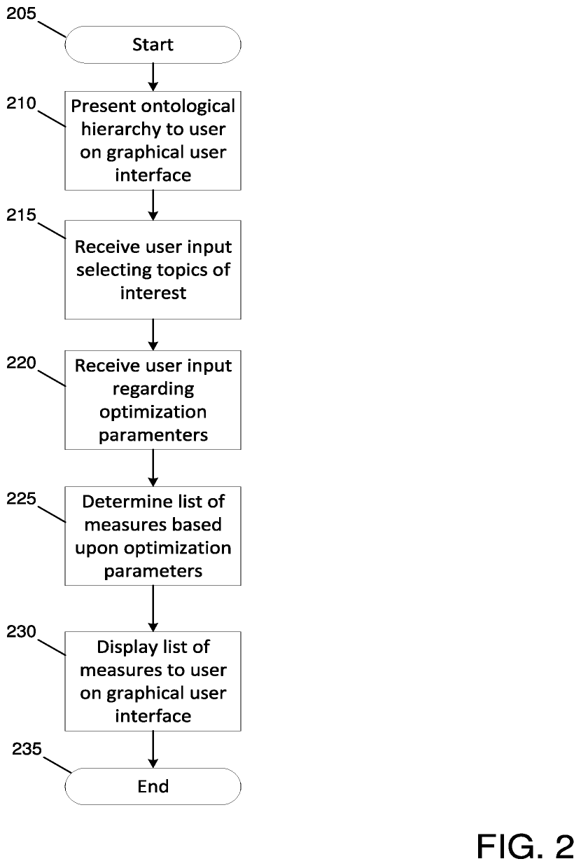

FIG. 2 illustrates a flow diagram of a user using the measure optimization system. The measure optimization system starts 205 and then presents the ontological hierarchy to the user 210 using the graphical user interface. This ontological hierarchy may be like that shown in FIG. 1. The measure optimization system then receives user inputs 215 from the user that indicate the topics of interest to the user. Using the graphical user interface 100, the user may select various topics of interest. Next, the measure optimization system receives user inputs 220 from the user that indicate the desired optimization parameters to be used to select measures. The measure optimization system then determines the list of measures based upon the optimization parameters 225. Such parameters may indicate that the user would like to minimize cost while still covering the topics of interest to the user. This may be accomplished using the first optimization described above. Alternatively, the user may want to maximize value within a fixed cost, where the user supplies the cost limitation. This may be accomplished using the second optimization described above. In yet another alternative, the user may use the hybrid approach described above by first providing a cost value used the second optimization. The values and topics determined from this optimization are then used in the first optimization to determine a set of measures. Finally, the measure optimization system displays a list of measures to the user on the graphical user interface 235, and then the method ends 240. This list of measures and associated data may be presented using the various ways described above.

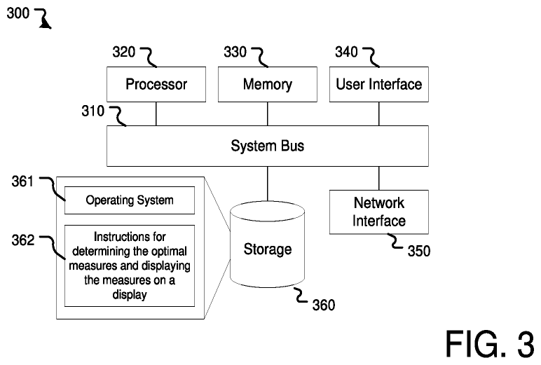

FIG. 3 illustrates an exemplary hardware diagram 300 for selecting a set of optimized measures and displaying those measures to a user. The hardware diagram 300 may implement the measure optimization system and the method a described in FIG. 2 and present the graphical user interface as illustrated in FIG. 1. As shown, the device 300 includes a processor 320, memory 330, user interface 340, network interface 350, and storage 360 interconnected via one or more system buses 310. It will be understood that FIG. 3 constitutes, in some respects, an abstraction and that the actual organization of the components of the device 300 may be more complex than illustrated.

The processor 320 may be any hardware device capable of executing instructions stored in memory 330 or storage 360 or otherwise processing data. As such, the processor may include a microprocessor, a graphics processing unit (GPU), field programmable gate array (FPGA), application-specific integrated circuit (ASIC), any processor capable of parallel computing, or other similar devices.

The memory 330 may include various memories such as, for example L1, L2, or L3 cache or system memory. As such, the memory 330 may include static random-access memory (SRAM), dynamic RAM (DRAM), flash memory, read only memory (ROM), or other similar memory devices.

The user interface 340 may include one or more devices for enabling communication with a user and may present information to users. For example, the user interface 340 may include a display, a touch interface, a mouse, and/or a keyboard for receiving user commands. In some embodiments, the user interface 340 may include a command line interface or graphical user interface that may be presented to a remote terminal via the network interface 350. The user interface 340 may be used to display the graphical user interface of FIG. 1.

The network interface 350 may include one or more devices for enabling communication with other hardware devices. For example, the network interface 350 may include a network interface card (NIC) configured to communicate according to the Ethernet protocol or other communications protocols, including wireless protocols. Additionally, the network interface 350 may implement a TCP/IP stack for communication according to the TCP/IP protocols. Various alternative or additional hardware or configurations for the network interface 350 will be apparent.

The storage 360 may include one or more machine-readable storage media such as read-only memory (ROM), random-access memory (RAM), magnetic disk storage media, optical storage media, flash-memory devices, or similar storage media. In various embodiments, the storage 360 may store instructions for execution by the processor 320 or data upon with the processor 320 may operate. For example, the storage 360 may store a base operating system 361 for controlling various basic operations of the hardware 300. The storage 362 may store instructions for determining the optimal measures and displaying the measures on a display as described above.

It will be apparent that various information described as stored in the storage 360 may be additionally or alternatively stored in the memory 330. In this respect, the memory 330 may also be considered to constitute a “storage device” and the storage 360 may be considered a “memory.” Various other arrangements will be apparent. Further, the memory 330 and storage 360 may both be considered to be “non-transitory machine-readable media.” As used herein, the term “non-transitory” will be understood to exclude transitory signals but to include all forms of storage, including both volatile and non-volatile memories.

While the system 300 is shown as including one of each described component, the various components may be duplicated in various embodiments. For example, the processor 320 may include multiple microprocessors that are configured to independently execute the methods described herein or are configured to perform steps or subroutines of the methods described herein such that the multiple processors cooperate to achieve the functionality described herein. Such plurality of processors may be of the same or different types. Further, where the device 300 is implemented in a cloud computing system, the various hardware components may belong to separate physical systems. For example, the processor 320 may include a first processor in a first server and a second processor in a second server.

The measure optimization system described herein provides a technological improvement over current systems that try to assist users in measuring the costs and performance associated with value-based care systems. The measure optimization system provides the user with a set of tools for selecting topics of interest related to value-based care to be optimized by selecting a set of measures to meet the optimization requirements. The measure optimization system uses an ontological hierarchy of value-base care topics and their associated measures to then determine which measures provide the optimal performance. The measure optimization system helps users determine which measures best help the user to optimize care in a cost effective manner to make the most of the available resources.

Any combination of specific software running on a processor to implement the embodiments of the invention, constitute a specific dedicated machine.

As used herein, the term “non-transitory machine-readable storage medium” will be understood to exclude a transitory propagation signal but to include all forms of volatile and non-volatile memory.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method for selecting a set of value-base healthcare measures, comprising:
presenting an ontological hierarchy to a user on a graphical user interface, wherein the ontological hierarchy includes the hierarchical relationship between healthcare measures and value-based healthcare topics;
receiving user input indicating a set of topics from the ontological hierarchy;
receiving user input indicating value-based optimization parameters;
determining a list of healthcare measures based upon the set of topics and optimization parameters; and
displaying a list of measures to the user on the graphical user interface.

2. The method of claim 1, wherein the ontological hierarchy includes an aim category, an aim sub-category, generic topic KPIs level, and a healthcare measures level.

3. The method of claim 1, wherein each healthcare measure has an associated topic coverage value and an implementation or measure cost.

4. The method of claim 1, wherein determining a list of healthcare measures based upon the set of topics and optimization parameters further comprises determining the list of healthcare measures that minimizes the total cost of the healthcare measures within the constraint that the set of topics are covered based upon a specified value for each topic.

5. (canceled)

6. The method of claim 1, wherein determining a list of healthcare measures based upon the set of topics and optimization parameters further comprises determining the list of healthcare measures that maximizes the total value of the topics within the constraint total cost of the healthcare measures is less than a cost constraint.

7. (canceled)

8. The method of claim 1, wherein determining a list of healthcare measures based upon the set of topics and optimization parameters further comprises:
determining a subset of the list of topics that maximizes the total value of the topics within the constraint total cost of the healthcare measures is less than a cost constraint; and
determining the list of healthcare measures that minimizes the total cost of the healthcare measures associated with the subset of topics within the constraint that the total cost of the healthcare measures is less than a cost constraint.

9. The method of claim 1, further comprising determining the coverage value of each topic and displaying the coverage value of each topic on the graphical user interface.

10. The method of claim 1, further comprising determining the coverage of each topic provided by each healthcare measure and displaying the coverage by each healthcare measure on the graphical user interface.

11. A measure optimization system for selecting a set of value-base healthcare measures, comprising:
a memory;
a processor coupled to the memory, wherein the processor is further configured to:
present a ontological hierarchy to a user on a graphical user interface, wherein the ontological hierarchy includes the hierarchical relationship between healthcare measures and value-based healthcare topics;
receive user input indicating a set of topics from the ontological hierarchy;
receive user input indicating value-based optimization parameters;
determine a list of healthcare measures based upon the set of topics and optimization parameters; and
display a list of measures to the user on the graphical user interface.

12. The system of claim 11, wherein the ontological hierarchy includes an aim category, an aim sub-category, generic topic KPIs level, and a healthcare measures level.

13. The system of claim 11, wherein each healthcare measure has an associated topic coverage value and an implementation cost.

14. The system of claim 11, wherein determining a list of healthcare measures based upon the set of topics and optimization parameters further comprises determining the list of healthcare measures that minimizes the total cost of the healthcare measures within the constraint that the set of topics are covered based upon a specified value for each topic.

15. (canceled)

16. The system of claim 11, wherein determining a list of healthcare measures based upon the set of topics and optimization parameters further comprises determining the list of healthcare measures that maximizes the total value of the topics within the constraint total cost of the healthcare measures is less than a cost constraint.

17. (canceled)

18. The system of claim 11, wherein determining a list of healthcare measures based upon the set of topics and optimization parameters further comprises:
determining a subset of the list of topics that maximizes the total value of the topics within the constraint total cost of the healthcare measures is less than a cost constraint; and
determining the list of healthcare measures that minimizes the total cost of the healthcare measures associated with the subset of topics within the constraint that the total cost of the healthcare measures is less than a cost constraint.

19. The system of claim 11, wherein the processor is further configured to determine the coverage value of each topic and displaying the coverage value of each topic on the graphical user interface.

20. The system of claim 11, wherein the processor is further configured to determine the coverage of each topic provided by each healthcare measure and displaying the coverage by each healthcare measure on the graphical user interface.
